(19) United States
(12) Patent Application Publication
(10) Pub. No.: US 2005/0095174 A1
(43) Pub. Date: May 5, 2005

(54) Semipermeable sensors for detecting analyte

(76) Inventor: David E. Wolf, Sudbury, MA (US)

Correspondence Address: Allison Johnson;Allison Johnson, P.A., 6016 Logan Ave. S., Minneapolis, MN, 55419, US

(21) Appl. No.: 10/698,591

(22) Filed: Oct. 31, 2003

(51) Int. Cl. G01N 21/00

(52) U.S. Cl. 422/82.08; 422/58

(57) ABSTRACT

A sensor for detecting an analyte is disclosed that includes a core including hydrogel, fluorescence reagent disposed in the core, a semipermeable coating surrounding the core, the semipermeable coating including a polydisperse polymer having a molecular weight from about 4 kDa to about 18 kDa and a polydispersity index greater than 1 and a biocompatible coating surrounding the semipermeable coating.

### BACKGROUND

The invention relates to preparing sensors for detecting analyte such as glucose.

Effectively treating diabetes requires monitoring changes in the level of the glucose in the diabetic individual. Currently, diabetics monitor their condition by repeatedly pricking their fingers to obtain blood samples for evaluation. Self-monitoring of glucose is discontinuous and does not provide real time information about the glucose level in the individual.

Various systems for continuous monitoring of glucose levels have been proposed including implantable sensors that include reagents capable of detecting glucose levels in vivo. It has been difficult, however, to achieve a useful implantable sensor due to the many factors that impact the ability of a sensor to function properly within host. The host's immune system, for example, may mount an attack against the sensor. The attack may cause the formation of a fibrous sheath around the sensor, which can impede and may prevent glucose from entering the sensor, rendering the sensor essentially useless. Various components of the host immune system can also attack the reagents of the sensor if such components are allowed to enter the sensor. If the sensor is too permeable, the reagents may leak out of the sensor into the host, which may cause harm to the host, and depletes the amount of reagent available for detecting the glucose. In addition, if the permeability of the sensor is too limited or if the reagents of the sensor respond too slowly to the changes in the host's glucose levels, the information provided by the sensor does not accurately portray the physiological condition of the host. It would be desirable to have a sensor that overcomes these difficulties and provides continuous monitoring of glucose over an extended period of time.

### SUMMARY

In one aspect, the invention features a sensor for detecting an analyte, the sensor including a core including hydrogel, fluorescence reagent disposed in the core, a semipermeable coating surrounding the core, the semipermeable coating including a polydisperse polymer having a molecular weight from about 4 kDa to about 18 kDa and a polydispersity index greater than 1, and a biocompatible coating surrounding the semipermeable coating. In some embodiments, the polydisperse polymer has a molecular weight from about 8 kDa to about 12 kDa. In other embodiments, the polydisperse polymer has a molecular weight from from about 9 kDa to about 10 kDa. In one embodiment, the polydisperse polymer has a molecular of about 9.4 kDa. In some embodiments, the polydisperse polymer has a polydispersity index from greater than 1 to about 1.5. In other embodiments, the polydisperse polymer includes polylysine.

In one embodiment the sensor has a diameter greater than 1 mm. In other embodiments, the sensor has a diameter of at least 1.25 mm. In another embodiment, the sensor has a diameter of at least 1.5 mm. In some embodiments, the sensor has a diameter no greater than 3 mm. In other embodiments, the sensor has a diameter no greater than 2.5 mm.

In some embodiments, the analyte includes glucose.

In one embodiment, the sensor is capable of detecting the analyte based on nonradiative fluorescence resonance energy transfer. In some embodiments, the fluorescence reagent includes an energy acceptor and an energy donor. In other embodiments, the fluorescence reagent is selected from the group consisting of carbocyanine dyes, sulfonated aminocourmarin dyes, sulfonated rhodamine dyes, and combinations thereof. In one embodiment, the fluorescence reagent includes glucose binding protein and a glycosylated substrate. In some embodiments, the glucose binding protein includes concanavalin A and the glycosylated substrate includes human serum albumin. In another embodiment, the fluorescence reagent includes a first carbocyanine dye having an excitation maximum at about 581 nm and an emission maximum at about 596 nm, concanavalin A, a second carbocyanine dye having an excitation maxima at about 675 nm and an emission maxima at about 694 nm, and human serum albumin. In other embodiments, the ratio of the first carbocyanine to concanavalin A is from about 0.1 to about 0.4. In some embodiments, the ratio of the first carbocyanine to concanavalin A is 0.2. In one embodiment, the ratio of the second carbocyanine to human serum albumin is from about 0.5 to about 0.9.

In some embodiments, the human serum albumin is glycoslyated and the molar ratio of glucose to human serum albumin is from about 7 to about 12.

In another aspect, the invention features a method of making a sensor including contacting droplets of an aqueous alginate composition with an ionic solution including at least 100 mM Group II cations to form a core including crosslinked gel, the aqueous alginate composition including a two fold dilution of a stock composition including at least 1% weight/volume alginate and having a viscosity of at least 1700 centipoises at about 25° C. In one embodiment, the ions include barium ions, calcium ions or a combination thereof.

In some embodiments, the alginate composition includes from about 1% weight/volume to about 10% weight/volume alginate. In other embodiments, the alginate composition includes from about 1% weight/volume to about 3% weight/volume alginate.

In one embodiment, the stock composition has a viscosity from about 1700 cps to about 2000 cps at about 25° C.

In other embodiments, the ionic solution includes from about 100 mM cations to about 300 mM cations.

In some embodiments the method further includes coating the core with a composition including polydisperse polymer having a polydispersity index greater than 1. In other embodiments the method further includes coating the core with a composition including polydisperse polymer having a polydispersity index from greater than 1 to about 1.5. In another embodiment, the method further includes coating the polydisperse polymer coating with a biocompatible composition. In one embodiment, the method further includes contacting the core with a composition including a fluorescence reagent.

In some embodiments, the aqueous alginate composition includes a fluorescence reagent. In one embodiment, the fluorescence reagent includes an energy donor and an energy acceptor. In other embodiments, the fluorescence reagent includes glucose binding protein and a glycosylated substrate. In one embodiment, the glucose binding protein includes concanavalin A and the glycosylated substrate includes human serum albumin. In some embodiments, the fluorescence reagent is selected from the group consisting of carbocyanine dyes, sulfonated aminocourmarin dyes, sulfonated rhodamine dyes, and combinations thereof. In other embodiments, the fluorescence reagent includes the group consisting of carbocyanine dyes, sulfonated aminocourmarin dyes, sulfonated rhodamine dyes, and combinations thereof. In another embodiment, the ratio of the first carbocyanine to concanavalin A is from about 0.1 to about 0.4. In other embodiments, the ratio of the first carbocyanine to concanavalin A is 0.2. In some embodiments, the ratio of the second carbocyanine to human serum albumin is from about 0.5 to about 0.9. In one embodiment, the glucose binding protein includes concanavalin A and the glycosylated substrate includes human serum albumin. In another embodiment, the human serum albumin is glycoslyated and the molar ratio of glucose to human serum albumin is from about 7 to about 12.

In other embodiments, the fluorescence reagent includes a first dye having an excitation maxima at about 578 nm and an emission maxima at about 603 mn, concanavalin A, a second dye having an excitation maxima at about 650 nm and an emission maxima at about 665 nm, and human serum albumin.

In some embodiments, the sensor exhibits less 1mole % leakage of its fluorescence reagent when stored for two weeks at 37° C. in pH 7.4 10 mM HEPES/0.15 M saline solution.

In another aspect, the invention features a sensor for detecting an analyte, the sensor including a core that includes a polymer matrix, fluorescence reagent disposed in the core, a semipermeable coating surrounding the core, the semipermeable coating comprising a polydisperse polymer, and a biocompatible coating surrounding the semipermeable coating. The sensor exhibits less than 1mole % leakage of the fluorescence reagent when stored for two weeks at 37° C. in pH 7.4 10 mM HEPES/0.15 M saline solution.

The present invention features an implantable, explantable sensor that is useful for detecting an analyte such as glucose. The sensor is sufficiently rigid to be implantable and explantable, and sufficiently deformable to experience the various forces that are encountered by the body during the course of a normal day without rupturing, sufficiently large to be palpable. The sensor is also sufficiently large to induce the host to form a sheath around the sensor, where the sheath formed is sufficiently thick to maintain the sensor in place and sufficiently thin to allow allowing the analyte of interest to diffuse into and out of the sensor at a physiologically useful rate. The sensor is sufficiently small to permit the analyte to diffuse into and out of the sensor at a physiologically useful rate. The sensor is sufficiently mechanically robust to be stable within a host for at least six, or even at least twelve months and sufficiently biocompatible so as not to elicit a fibrotic response detrimental to the proper functioning of the sensor over a period of at least six, or even at least twelve months. The sensor is sufficiently permeable to allow analyte to diffuse into and out of the sensor at a physiologically relevant rate, and sufficiently impermeable such that reagents remain within the sensor (i.e., the sensor is free of or essentially free of reagent leakage) and IgG is impeded and essentially prevented from passing into the sensor.

Other features and advantages will be apparent from the following description of the preferred embodiments and from the claims

### GLOSSARY

In reference to the invention, these terms have the meanings set forth below:

As used herein, the term “fluorophore” refers to a molecule that absorbs energy and then emits light.

As used herein, the term “analyte-analogue” refers to a material that has at least some binding properties in common with those of the analyte such that there are ligands that bind to both. The analyte-analogue and the analyte, however, do not bind to each other. The analyte-analogue may be a derivative of the analyte such as a compound prepared by introducing functional chemical groups onto the analyte that do not affect at least some of the binding properties of the analyte. Another example of a derivative is a lower molecular weight version of the analyte, which retains at least some of the binding properties of the analyte. Another example of a derivative is a covalent conjugate of the analyte or multiple copies of the analyte to a carrier protein.

As used herein, the term “biocompatible” refers to being acceptable to the host's immune system, i.e., eliciting a minimal immune response and being nontoxic to the host.

As used herein, the term “fluorescence” refers to radiation emitted in response to excitation by radiation of a particular wavelength. It includes both short lived (nanosecond range) and long-lived excited state lifetimes; the latter is sometimes referred to as phosphorescence.

As used herein, the term “fluorescence reagent” refers to a component whose fluorescence behavior (e.g., intensity, emission excited state lifetime, spectrum, or excitation spectrum) changes in the presence of the analyte being detected.

As used herein references to an emission maxima or an excitation maxima are with respect to values obtained in water.

### DRAWINGS

FIG. 1A is a graphic representation of absorbance and emission spectra of donor and acceptor molecules.

FIG. 1B is a representation of non-radiative energy transfer.

FIG. 2 is a color photograph of a sensor that includes an alginate coating surrounding a crenellated polylysine-coated alginate core as taken through the objective of a stereo dissecting microscope at 20× power.

FIG. 3 is a plot of leakage data obtained for Example 1.

FIG. 4 is a bar graph illustrating leakage of Cy3.5 at day 14 for the beads of Comparative Examples 1-3 and Example 1.

### DETAILED DESCRIPTION

The sensor includes a core that includes a polymer matrix and a reagent disposed in the polymer matrix, a semipermeable coating that includes a polydisperse polymer surrounding the core, and a biocompatible coating surrounding the semipermeable coating. The sensor is constructed to retain the reagent while allowing analyte to diffuse into and out of the sensor at a rate that provides meaningful information about the physiological condition to which the analyte is relevant. The sensors can be constructed to be suitable for use in vivo, in vitro or a combination thereof and can be used to detect analyte in a variety of liquids including, e.g., body fluids (e.g., blood, plasma, serum, subcutaneous fluid, and peritoneal fluid). Analyte is then detected (and optionally quantified) by exciting the reagent of the sensor and detecting the radiation emitted by the sensor.

Preferred sensors are sufficiently large to be palpable when implanted subcutaneously (i.e., so that they can be easily located for subsequent explantation) and sufficiently large to induce the host to form a sheath around the sensor. The sheath functions to maintain (e.g., immobilize) the sensor in position in the host. The sheath preferably is of a thickness that is sufficiently small to enable the analyte to diffuse into and out of the sensor at a physiologically relevant rate.

The sensor is also sufficiently small such that the analyte is able to diffuse into and out of the sensor at a physiologically relevant rate, and the reagents within the sensor respond to the changes in the physiological condition at a physiologically relevant rate. For a sensor of arbitrary shape the characteristic time for diffusion of analyte into the sensor can be expressed in terms of the average distance between the center of the sensor and points on the surface. If this distance is called x, and D is the diffusion coefficient for the analyte, then the characteristic time (t) for diffusion of the analyte through the sensor can be expressed as t=x²/6D.

Preferred sensors are spherical and have a diameter greater than 1 mm, at least 1.25 mm, at least 1.5 mm, no greater than 3 mm, or even no greater than 2.5 mm.

Useful sensors have a variety of shapes including, e.g., spherical, cylindrical, elliptical, oval, and discoidal. The sensors can be constructed to include a number of cores, i.e., a number of polymer matrices, surrounded by a common polymer matrix.

The sensor preferably has an index of refraction that is substantially the same as the index of refraction of water rendering it free of light scattering properties and substantially transparent in an aqueous environment.

The sensor preferably has sufficient mechanical strength (e.g., rigidity) to enable implantation in and explantation from a host and sufficiently deformable to absorb the forces experienced by a host during the course of a normal day. The sensor preferably exhibits sufficient mechanical strength to enable the sensor to remain implanted within a host for an extended period of time including, e.g., at least six months, or even at least twelve months, without becoming crushed or losing its integrity.

The mechanical strength of the sensor can be derived from the polymer matrix, the semipermeable coating, the biocompatible coating and combinations thereof. Mechanical strength can also be imparted to the sensor through the presence of a protective carrier or casing. Such casings include, e.g., a mesh envelope made of metal (e.g., titanium, platinum, gold and combinations thereof). The mechanical strength of the polymer matrix can be altered by altering the concentration of the crosslinkable component used to form the polymer matrix and the degree of crosslinking of the polymer matrix. The polymer matrix preferably is prepared from a crosslinkable composition such that the final matrix when fully hydrated is at least 50%, 90%, 92%, 95%, 98%, or even 99% water by volume.

Preferably the polymer matrix is a hydrogel. Hydrogels can be formed from a crosslinkable component such as alginate. A useful crosslinkable alginate composition is prepared from a stock solution of alginate having a viscosity of at least 1700 centipoises (cps), or even from 1700 cps to about 2000 cps at room temperature (i.e., from about 22° C. to about 25° C.), which is diluted 1:1 prior to use, to form a crosslinkable composition that includes at least 1% weight/volume (w/v), from about 1% w/v to about 10% w/v, or even from about 1% w/v to about 3% w/v alginate in water.

The alginate is preferably crosslinked by dropping the alginate composition in a concentrated ionic solution including at least 100 mM (millimolar), from about 100 mM to about 300 mM, or even from about 100 mM to about 150 mM ions. Useful ions include Group II cations including, e.g., calcium ions, barium ions, magnesium ions, and combinations thereof.

Preferred alginate gels are derived from alginate that includes blocks of 1,4-linked (D-mannuronic acid) (M) and (−1-glucoronic acid) (G) linked together, e.g., in alternating MG blocks. Preferred alginate includes a high G block content, e.g., at least about 60% G block. As the percentage of G blocks in the alginate composition increases, the pore size and the strength of the resulting gel matrix increases. Alginate gels having a high M block content appear to be more immunogenic relative to gels having a high G block content.

Other suitable gels include any gel capable of forming a core having sufficient strength to maintain the desired shape of the sensor. Examples of useful hydrogels include, e.g., carrageenan, gum (e.g., xanthan gum), agarose, agar, collagen, gelatin, chitosan, polyethylene glycol, polyethylene oxide, and combinations thereof. Other useful polymer matrices include, e.g., polyacrylamide, polyacrylate, polymethacrylate, and combinations thereof.

Suitable methods for forming a polymer matrix include, e.g., adding water to a gel forming composition, exposing a crosslinkable composition to a crosslinking agent, changing the temperature (e.g., heating) of a gel forming composition, exposing a gel forming composition to radiation, and combinations thereof. The conditions for forming the polymer matrix are selected such that the integrity of the components of the sensor is maintained. The degree of crosslinking of the polymer matrix can be altered by changing the concentration of the crosslinkable component in the composition, concentration of the crosslinking agent, the environmental conditions of the crosslinking process (e.g., temperature, pH, salinity and radiation), the addition of chain transfer agent, the addition of initiators, and combinations thereof.

Alternatively the core can include an aqueous solution, in which case the semipermeable membrane is selected to provide sufficient rigidity to the sensor to render it suitable for implantation and explantation.

The core can be of a variety of shapes including, e.g., spherical, oblate spheroidal, prolate spheroidal, cylindrical and discoidal. Preferably the core is in the form of a spherical bead. Any suitable method of making a microspherical bead can be used to form the core including, e.g., emulsification, electrospraying, dripping, Raleigh jet (e.g., an air jet), and casting. Useful methods of making cylindrical and disc shaped cores include, e.g., extrusion followed by cutting, and casting.

The porosity of the polymer matrix impacts the migration of components through the polymer matrix and can be altered in several ways including, e.g., altering the concentration of the crosslinkable component in the composition used to form the polymer matrix, altering the average molecular weight of the crosslinkable material, altering the molecular weight dispersity of the crosslinkable component, altering the composition of the crosslinkable component, doping the crosslinkable component with other crosslinkable component, using different crosslinking agents, altering the degree of hydroxylation of the crosslinkable component and combinations thereof. Components that can be added to alginate to alter a gel produced therefrom include, e.g., gelatin and collagen. Other suitable crosslinking agents include, e.g., barium ions, other ions with the same valance as calcium ions, protein crosslinking agents (e.g., lectins such as concavalin A), photo induced crosslinking agents, chemical crosslinking agents (e.g., gluteraldehyde), and combinations thereof. Charge can also be added or subtracted from a gel matrix to alter its porosity. Various useful mechanisms for altering the porosity of alginate are described, e.g., in Thesis of Thu, B. J. entitled, “Alginate polycation microcapsules: A study of some molecular and functional properties relevant to their use as a bioartificial pancreas,” Norwegian University of Science and Technology, pages 35-46 (August 1996), and include altering the ratio of M blocks to G blocks in the alginate.

The temperature of the crosslinkable composition used to form a hydrogel can affect the pore size of the resulting gel matrix. An increase in the temperature of the crosslinkable composition, for example, will result in shrinkage of the hydrogel, which can decrease the porosity of the hydrogel.

The polymer matrix of the core preferably has an index of refraction that is substantially the same as the index of refraction of water, does not fluoresce in the wavelength range that is used to excite the reagents of the sensor, and is free of light scattering properties.

The outer surface of the sensor preferably is sufficiently smooth so as to minimize, and preferably eliminate, light scattering. The smoothness of the sensor surface is determined by viewing the sensor under a stereo dissecting microscope operated under transmitted light ring illuminated at an objective power of from 0.8× to 5×, an eye piece at 10 power and a total power of from 8× to 50×. One useful method of forming a smooth sensor includes forming a smooth core by dispensing droplets of a crosslinkable composition into a highly concentrated crosslinking agent and allowing the crosslinkable composition to crosslink at a rapid rate to form a hydrogel core, preferably under conditions that minimize vibration (e.g., vibration isolation). Useful concentrated crosslinking agent compositions suitable for crosslinking alginate include the above-described crosslinkable compositions and ionic crosslinking solutions, which description is incorporated herein.

The core of the sensor also includes a reagent capable of detecting the presence of an analyte. The reagent preferably is mobile in the polymer matrix. The reagent of the sensor can include more than one component. The reagent is suitable for detecting the analyte in a liquid, e.g., body fluid (e.g., blood and interstitial fluid). Useful reagents include, e.g., energy absorbing reagents (e.g., light absorbing and sound absorbing reagents), x-Ray reagents, spin resonance reagents, nuclear magnetic resonance reagents, and combinations thereof. In some embodiments, the reagent exhibits a valence sufficient to allow the reagents to aggregate thereby increasing the signal emitted by the reagent during a binding event or, in the alternative, in the absence of a binding event. Aggregation of the reagent also assists in maintaining the reagent in the sensor, i.e., the reagent does not pass out of the sensor through the semipermeable coating. Preferably the reagent is multivalent, e.g., includes at least two binding sites capable of binding the analyte. In the case of reagents based on nonradiative fluorescence energy transfer, as discussed in more detail below, the reagent can include an analyte-analogue and a ligand capable of binding the analyte-analogue. Preferably the analyte-analogue includes at least two binding sites for a ligand. Preferred reagents have a valence of at least 2, from 2 to 15, or even from 3 to 10.

The reagent is selected such that skin and other components of the body disposed between the detector and the sensor do not interfere with the signal emitted by the reagent. Preferred reagents emit a light signal in a wavelength within the range over which skin is transparent, preferably the reagents emit in the range of 600 nm to 1100 nm.

A useful class of reagents includes fluorescence reagents, i.e., reagents that include a fluorophore or a compound labeled with a fluorophore. The fluorescence reagent can reversibly bind to the analyte and the fluorescence behavior of the reagent changes when analyte binding occurs.

Changes in fluorescence associated with the presence of the analyte may be measured in several ways. These changes include changes in the excited state lifetime of, or fluorescence intensity emitted by, the fluorophore (or component labeled with the fluorophore). Such changes also include changes in the excitation or emission spectrum of the fluorophore (or component labeled with the fluorophore). Changes in the excitation or emission spectrum, in turn, may be measured by measuring (a) the appearance or disappearance of emission peaks, (b) the ratio of the signal observed at two or more emission wavelengths, (c) the appearance or disappearance of excitation peaks, (d) the ratio of the signal observed at two or more excitation wavelengths or (e) changes in fluorescence polarization.

The reagent can be selected to exhibit non-radiative fluorescence resonance energy transfer (FRET), which can be used to determine the occurrence and extent of binding between members of a specific binding pair.

Basic Elements of FRET

FRET generally involves the non-radiative transfer of energy between two fluorophores, one an energy donor (D) and the other an energy acceptor (A). Any appropriately selected donor-acceptor pair can be used, provided that the emission of the donor overlaps with the excitation spectra of the acceptor and both members can absorb light energy at one wavelength and emit light energy of a different wavelength.

Alternatively, both the donor and acceptor can absorb light energy, but only one of them emits light energy. For example, one molecule (the donor) can be fluorescent and the other (the acceptor) can be nonfluorescent. It is also possible to make use of a donor-acceptor pair in which the acceptor is not normally excited at the wavelength used to excite the (fluorescent) donor; however, nonradiative FRET causes acceptor excitation.

The excitation wavelength may be selected such that it predominantly excites only the donor molecule. The use of the term “predominantly” reflects that due to bleed-through phenomena, it is possible that there will be some acceptor excitation as well. Thus, as used herein, “excitation” of donor or acceptor refers to an excitation wavelength that predominantly excites donor or acceptor. Following excitation, non-radiative fluorescence resonance energy transfer is determined by measuring the ratio of the fluorescence signal at two emission wavelengths, one of which is due to donor emission and the other of which is due to acceptor emission. Just as in the case of excitation, there may be some “bleeding” of the fluorescence signal such that acceptor emission makes a minor contribution to the donor emission signal, and vice versa. Thus, whenever a signal is referred to as being “due to” donor emission or acceptor emission, it is meant that the signal is predominantly due to donor emission or acceptor emission.

Alternatively, the excitation may be selected such that it excites the donor at a first wavelength and the acceptor at a second wavelength. In other words, two separate excitation events, each at different wavelength, are used. In this case, nonradiative fluorescence energy transfer is determined by measuring the ratio of the fluorescence signal due to the acceptor following donor excitation and the fluorescence signal due to the acceptor following acceptor excitation.

FRET can also be measured by assessing whether there is a decrease in donor lifetime, a quenching of donor fluorescence intensity, or an enhancement of acceptor fluorescence intensity; the latter two are measured at a wavelength in response to excitation at a different wavelength (as opposed to the ratio measurements described above, which involve either measuring the ratio of emissions at two separate wavelengths or measuring the ratio of emission at a wavelength due to excitation at two separate wavelengths).

Although the donor and the acceptor are referred to herein as a “pair,” the two “members” of the pair can be the same substance. Generally, the two members will be different (e.g., Cy 3.5 and Cy 5.5). It is possible for one molecule (e.g., Cy 3.5 or Cy 5.5) to serve as both donor and acceptor; in this case, energy transfer is determined by measuring depolarization of fluorescence.

Particularly useful reagents for a FRET-based sensor capable of detecting glucose includes an acceptor that includes Cy5.5 bonded to concanavalin A (e.g., recombinant concanavalin A) at a dye to protein ratio of from about 0.1 to about 0.4, or even about 0.2 and a donor that includes Cy3.5 bonded to human serum albumin at a dye to protein ratio of from about 0.5 to about 0.9 and an glucose to protein ratio of from about 7 to about 12. Cy3.5 is a carbocyanine dye having an excitation maximum at 581 nm and an emission maximum at 596 nm as reported by the manufacturer, Amersham BioSciences (Cardiff Wales)). Cy5.5 is a carbocyanine dye having an excitation maxima at 675 nm and an emission maxima at 694 nm as reported by the manufacturer, Amersham BioSciences.

Another useful reagent includes a donor that includes ALEXA568 bonded to concanavalin A (e.g., recombinant concanavalin A) and an acceptor that includes ALEXA647 bonded to human serum albumin. ALEXA568 has an excitation maxima at about 578 nm and an emission maxima at about 603 nm as reported by the manufacturer, Molecular Probes, (Eugene, Oreg.)). ALEXA647 has an excitation maxima at about 650 nm and an emission maxima at about 665 nm as reported by the manufacturer, Molecular Probes.

Other examples of donor/acceptor pairs are NBD N-(7-nitrobenz-2-oxa 1,3-diazol-4yl) to rhodamine, NBD or fluorescein to eosin or erythrosin, dansyl to rhodamine, and acridine orange to rhodamine. As used herein, the term fluorescein refers to a class of compounds that includes a variety of related compounds and their derivatives. Similarly, as used herein, the term rhodamine refers to a class of compounds which includes a variety of related compounds and their derivatives.

Preferably the sensor includes reagents that are capable of being excited at wavelengths from 400 nm to 800 nm, 532 nm, 635 nm, 645 nm, 655 nm, 660 nm, or even 670 nm, and capable of emitting at wavelengths from 600 nm to 1100 nm, or even from 600 nm to 700 nm. Useful classes of fluorophore-containing dyes include, e.g., carbocyanine dyes, sulfonated forms of aminocourmarin and rhodamine, and combinations thereof. The chemistry of some of these dyes is further discussed, e.g., in Panchuk-Voloshina, Nataliya et al., “Alexa Dyes, a Series of New Fluorescent Dyes that Yield Exceptionally Bright, Photostable Conjugates,” The Journal of Histochemistry and Cytochemistry, vol. 47(9) 1179-1188 (1999). Useful commercially available fluorophore-containing dyes, their manufacturer's and their corresponding approximate emission maxima are set forth below in Table 1.

TABLE 1

| | | Approximate Emission |
|---|---|---|
| | | Maximum or region of |
| Dye | Vendor | measurement in nm |
| Alexa 546 | Molecular Probes¹ | 573 |
| Alexa 555 | Molecular Probes | 565 |
| Alexa 568 | Molecular Probes | 603 |
| Alexa 594 | Molecular Probes | 617 |
| Alexa 610 | Molecular Probes | 628 |
| Alexa 633 | Molecular Probes | 647 |
| Alexa 647 | Molecular Probes | 665 |
| Alexa 660 | Molecular Probes | 690 |
| Alexa 680 | Molecular Probes | 702 |
| Alexa 700 | Molecular Probes | 723 |
| Alexa 750 | Molecular Probes | 775 |
| Bodipy630/650 | Molecular Probes | 640 |
| Bodipy 650/665 | Molecular Probes | 660 |
| Cy 3 | Amersham BioSciences² | 570 |
| Cy 3B | Amersham BioSciences | 572 |
| Cy 3.5 | Amersham BioSciences | 596 |
| Cy 5 | Amersham BioSciences | 670 |
| Cy 5.5 | Amersham BioSciences | 694 |
| Cy 7 | Amersham BioSciences | 767 |
| Oyster 556 | DeNovo³ | 570 |
| Oyster 645 | DeNovo | 666 |
| Oyster 656 | DeNovo | 674 |

¹Molecular Probes, Eugene, Oregon.
²Amersham BioSciences, Cardiff Wales.
³DeNovo Biolabels GmbH, Munster, Germany.

Useful pairs of energy donors and energy acceptors are set forth below in Table 2.

TABLE 2

| Donor | Acceptor |
|---|---|
| NBD | Rhodamine |
| NBD | Eosin |
| NBD | Erythrosine |
| fluorescein | Eosin |
| fluorescein | Erythrosine |
| fluorescein | Rhodamine |
| dansyl | Rhodamine |
| acridine orange | Rhodamine |
| Cy 3.0 | Cy 5.0 |
| Cy 3.0 | Cy 5.5 |
| Cy 3.5 | Cy 5.0 |
| Cy 3.5 | Cy 5.5 |
| Cy 5.0 | Cy 7.0 |
| Cy 5.5 | Cy 7.0 |
| Bodipy (630/650) | Bodipy (650/665) |
| ALEXA 546 | ALEXA 594 |
| ALEXA 555 | ALEXA 594 |
| ALEXA 555 | ALEXA 610 |
| ALEXA 568 | ALEXA 633 |
| ALEXA 594 | ALEXA 647 |
| ALEXA 594 | ALEXA 660 |
| ALEXA 610 | ALEXA 647 |
| ALEXA 610 | ALEXA 660 |
| ALEXA 633 | ALEXA 660 |
| ALEXA 647 | ALEXA 700 |
| ALEXA 660 | ALEXA 700 |
| ALEXA 680 | ALEXA 750 |
| ALEXA 700 | ALEXA 750 |
| Oyster 556 | Oyster 645 |
| Oyster 556 | Oyster 656 |
| Oyster 645 | Oyster 656 |

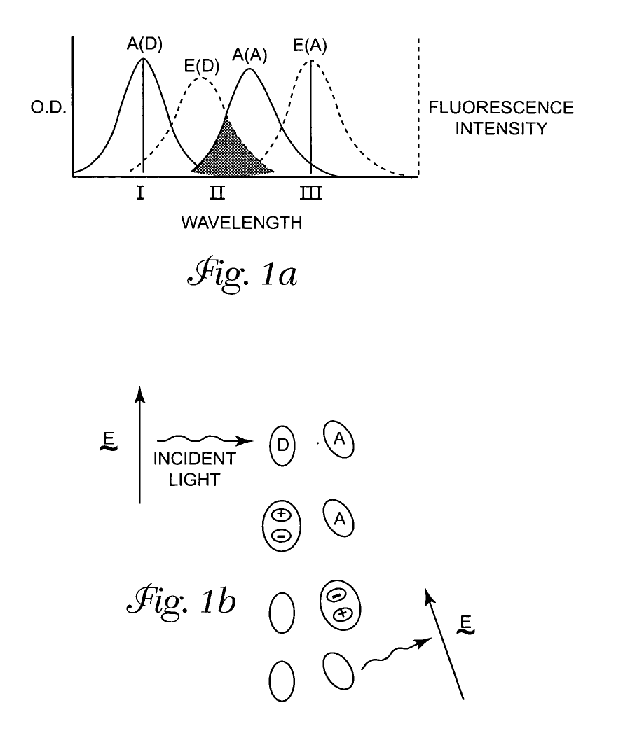

The concept of FRET is represented in FIG. 1. The absorbance and emission of donor, designated A(D), and E(D), respectively, and the absorbance and emission of acceptor, designated A(A) and E(A), respectively, are represented graphically in FIG. 1A. The area of overlap between the donor emission and the acceptor absorbance spectra (which is the overlap integral) is of importance. If excitation occurs at wavelength I, light will be emitted at wavelength II by the donor, but not at wavelength III by the acceptor because the acceptor does not absorb light at wavelength I.

The non-radiative transfer process that occurs is represented in FIG. 1B. D molecule absorbs the photon whose electric field vector is represented by E. The excited state of D is shown as a dipole with positive charge on one side and negative charge on the other. If an acceptor molecule (A) is sufficiently close to D (e. g., typically less than 100 Angstroms), an oppositely charged dipole is induced on it (it is raised to an excited state). This dipole-induced dipole interaction falls off inversely as the sixth power of donor-acceptor intermolecular distance.

Classically, partial energy transfer can occur. However, this is not what occurs in FRET, which is an all or nothing quantum mechanical event. That is, a donor is not able to give part of its energy to an acceptor. All of the energy must be transferred and energy transfer can occur only if the energy levels (i.e., the spectra) overlap. When A leaves its excited state, the emitted light is rotated or depolarized with respect to the incident light. As a result, FRET manifests itself as a decrease in fluorescence intensity (i.e., decrease in donor emission) at II, an appearance of fluorescence intensity at III (i.e., an increase in sensitized emission) and a depolarization of the fluorescence relative to the incident light.

A final manifestation of FRET is in the excited state lifetime. Fluorescence can be seen as an equilibrium process, in which the length of time a molecule remains in its excited state is a result of competition between the rate at which it is being driven into this state by the incident light and the sum of the rates driving it out of this state (fluorescence and non-radiative processes). If a further nonradiative process, FRET, is added (leaving all else unchanged), decay is favored, which means donor lifetime at II is shortened.

When two fluorophores whose excitation and emission spectra overlap are in sufficiently close proximity, the excited state energy of the donor molecule is transferred by a resonance dipole-induced dipole interaction to the neighboring acceptor fluorophore. In FRET, a sample or mixture is illuminated at a wavelength, which excites the donor but not the acceptor molecule directly. The sample is then monitored at two wavelengths; that of donor emissions and that of acceptor emissions.

If donor and acceptor are not in sufficiently close proximity, FRET does not occur and emissions occur only at the donor wavelength. If donor and acceptor are in sufficiently close proximity, FRET occurs. The results of this interaction are a decrease in donor lifetime, a quenching of donor fluorescence, an enhancement of acceptor fluorescence intensity, and depolarization of fluorescence intensity. The efficiency of energy transfer, Et, falls off rapidly as the distance between donor and acceptor molecule, R, increases. For an isolated donor acceptor pair, the efficiency of energy transfer is expressed as:
Et=1/[1+(R/Ro)⁶] (1)
where R is the separation distance between donor and acceptor and Ro is the distance for half transfer. Ro is a value that depends upon the overlap integral of the donor emission spectrum and the acceptor excitation spectrum, the index of refraction, the quantum yield of the donor, and the orientation of the donor emission and the acceptor absorbance moments. Forster, T., Z Naturforsch. 4A, 321-327 (1949); Forster, T., Disc. Faraday Soc. 27,7-17 (1959).

Because of its 1/R⁶ dependence, FRET is extremely dependent on molecular distances and has been dubbed “the spectroscopic ruler.” (Stryer, L., and Haugland, R. P., Proc. Natl. Acad. Sci. USA, 98: 719 (1967). For example, the technique has been useful in determining the distances between donors and acceptors for both intrinsic and extrinsic fluorophores in a variety of polymers including proteins and nucleic acids. Cardullo et al. demonstrated that the hybridization of two oligodeoxynucleotides could be monitored using FRET (Cardullo, R., et al., Proc. Natl. Acad. Sci., 85: 8790-8794 (1988)).

Concept of Using FRET for Analyte Detection

In general, FRET is used for analyte detection in one of two ways. The first is a competitive assay in which an analogue to the analyte being detected and a ligand capable of binding to both analogue and analyte are labeled, one with a donor fluorophore and the other with an acceptor fluorophore. Thus, the analogue may be labeled with donor and the ligand with acceptor, or the analogue may be labeled with acceptor and the ligand with donor. When the labeled reagents contact analyte, analyte displaces analogue bound to ligand. Because ligand and analogue are no longer close enough to each other for FRET to occur, the fluorescence signal due to FRET decreases; the decrease correlates with the concentration of analyte (the correlation can be established in a prior calibration step).

To be able to reuse the fluorescence reagents, the binding between analyte and ligand should be reversible under physiological conditions. Similarly, the equilibrium binding constants associated with analyte-ligand binding and analogue-ligand binding should be such that analyte can displace analogue. In other words, analogue-ligand binding should not be so strong that analyte cannot displace analogue.

Preferably the sensor is free of inner filter effects caused by the reagent of the sensor. The requirement of minimal inner filter effect has different consequence depending upon the properties of the sensor chemistry. In the case where the reagent includes a fluorophore, inner filter effects can occur when the concentration of the fluorescence reagent is sufficiently high to cause significant reabsorption of emitted light. If the reagent functions by a direct alteration in fluorescence upon analyte binding and if the binding constant for analyte lies in the desired range of measurement, then minimization of inner filter effects may be achieved by lowering the concentration of fluorescence reagent within the sensor while maintaining a sufficient fluorescence signal. In the case where the reagent functions by FRET between a fluorescent analyte analogue and a fluorescent analyte binding agent, inner filter effects can be minimized by choosing reagents that interact with each other with a much higher affinity than the interaction between analyte and analyte binding agent but where the affinity for analyte falls in the desired concentration range. A similar approach can be used with any competitive fluorescence assay. The sensor chemistry described in U.S. Pat. No. 5,342,789, for example, has micromolar affinity between reagents but detects glucose with an affinity in the millimolar range.

The reagent can be incorporated into the core in a number of methods. According to one method, the reagent is added to the crosslinkable composition prior to forming the core. According to another method, the core is placed in a composition that includes the reagent and the reagent is allowed to permeate the core.

The semipermeable coating of the sensor is a porous polymer coating prepared from a variety of polymers including, e.g., heteroploymers, homopolymers and mixtures thereof. The permeability of the coating is such that the analyte of interest flows in and out of the sensor, which allows the measurement of physiologically relevant changes of the analyte, the reagents within the sensor remain within the sensor (i.e., the host is not exposed to the reagents), the analyte of interest is allowed to come into contact with the reagent, and components of a predetermined molecular weight are inhibited, and preferably prevented, from entering the sensor. The type and molecular weight of the polymer from which the semipermeable coating is prepared and the thickness of the coating are selected to provide the desired permeability. Preferably the sensor exhibits less than 5 mole %, less than 1 mole %, less than 0.5 mole %, or even less than 0.2 mole % leakage of the fluorescence reagent after two weeks at 37° C.

Preferably the semipermeable coating is prepared from polydisperse polymer having a weight average molecular weight of from about 4 kiloDaltons (kDa) to about 18 kDa, from about 8 kDa to about 12 kDa, or even from about 9 kDa to about 10 kDa. Preferred polydisperse polymers have a polydispersity index Mn/Mw (dI) greater than 1, from greater than 1.0 to about 1.5, or even from about 1.1 to 1.4.

Examples of useful polymers include polyamino acids (e.g., polylysine and polyornithine), polynucleotides, and combinations thereof. Preferred polymers include, e.g., polyamino acids having a length of from 19 to 60 amino acids, from 38 to about 60 amino acids, or even from about 43 to about 48 amino acids. Suitable polydisperse polyamino acids are available from Sigma Chemical Company (St. Louis, Mo.).

The semipermeable coating can include a mixture of monodisperse polymers of different molecular weights. Without wishing to be bound by theory, the inventors surmise that the lower molecular weight polymers fill the smaller regions on the surface of the core, as well as the spaces between higher molecular weight polymers.

The semipermeable coating can include multiple layers in which each layer is prepared from the same polymer composition or a different polymer composition. For example, the semipermeable coating can include one or more layers of polydisperse polymers, monodisperse polymers, and combinations thereof. Useful monodisperse polymers include monodisperse polyamino acids including, e.g., poly-L-lysine monodisperese homopolymers having 33, 47 and 60 residues.

In some cases, although multiple layers have been applied to the sensor, the individual layers may not be individually discernable.

Preferably the semipermeable coating excludes IgG and complement (e.g., complement C1q). Preferably the semipermeable coating excludes molecules having a molecular weight greater than 100 kDa, greater than 60 kDa, or even greater than 30 kDa from entering the sensor.

The composition of the semipermeable coating can be selected to reduce the volume of the core. Coating compositions that include relatively low molecular weight polydisperse polyamino acid (e.g., a polylysine or polyornithine) can significantly reduce the volume of the gel core to which it is applied. In many cases the reduction in volume is at least about 50%, at least 60%, or even at least 70%. Preferably the molecular weight of the polyamino acid is no greater than about 30,000 Da, no greater than about 15 kDa, no greater than about 10 kDa, no greater than about 8 kDa, no greater than about 7 kDa, no greater than about 5 kDa, no greater than about 4 kDa, no greater than about 3 kDa, or even no greater than about 1.5 kDa.

Polydisperse polylysine having a molecular weight of 3 kDa, 7 kDa, 9.6 kDa, or even 12 kDa, can result in a significant reduction (approximately 30% in some cases) in the diameter of the core to which the coating it is applied.

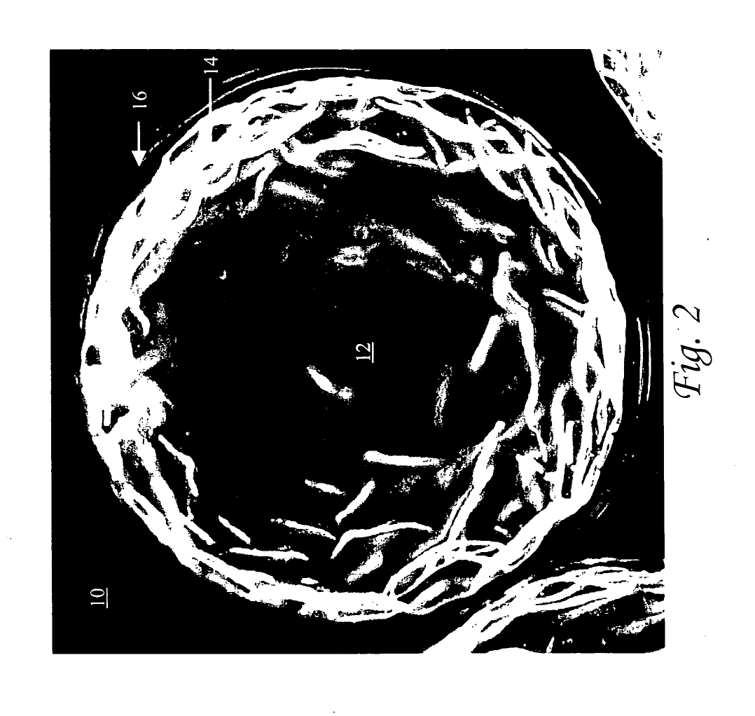

The low molecular weight polyamino acid also forms a coating having good permselective properties and can produce a surface that is “pruned” or crenellated, i.e., relatively convoluted or rough. Such pruned surfaces may elicit a fibrotic response. The application of alginate to the pruned surface can provide a relatively smooth surface on the exterior of the sensor, which inhibits fibrosis and reduces light scattering effects. FIG. 2 illustrates a sensor 10 that includes an alginate coating 16 surrounding a crenellated polylysine-coated 14 alginate core 12 as observed on a stereo dissecting microscope (Carl Ziess Inc., Thornwood, N.Y.) operated under transmitted light ring illuminated at a total power of 20×.

The exterior surface of the sensor is sufficiently biocompatible so as not to induce a fibrotic response from the host's immune system that will impair or prevent the diffusion of the analyte of interest into and out of the sensor at a physiologically relevant rate, while being sufficiently nonbiocompatible so as allow the host to form a sheath around the sensor to maintain the sensor in position in the host. Suitable biocompatible coating compositions include the crosslinkable compositions described above (and incorporated herein) with respect to the polymer matrix of the core and include, e.g., hydrogels (e.g., alginate and agarose).

Useful methods of providing biocompatible coatings are described, e.g., in U.S. Pat. No. 6,126,936.

Preferably the sensor is coated with a layer of biocompatible coating sufficiently thick to fully envelope the sensor. The external biocompatible coating preferably has a thickness of at least 1 microns (μm), from about 1 μm to about 25 μm, or even from about 5 μm to about 20 μm.

The external coating preferably is sufficiently smooth so as not to induce a fibrotic response from the host that will impede or prevent analyte from diffusing into and out of the sensor. A discussion of the fibrotic response can be found in U.S. patent application Ser. No. 10/095,503 filed Mar. 11, 2002, entitled, “MICROREACTOR AND METHOD OF DETERMINING A MICROREACTOR SUITABLE FOR A PREDETERMINED MAMMAL.”

The sensor can be constructed to be suitable for detecting a variety of analytes including, e.g., carbohydrates (e. g., glucose, fructose, and derivatives thereof). As used herein, “carbohydrate” refers to any of the group of organic compounds composed of carbon, hydrogen, and oxygen, including sugars, starches and celluloses. Other suitable analytes include glycoproteins (e. g., glycohemoglobin, thyroglobulin, glycosylated albumin, glycosylated albumin, and glycosylated apolipoprotein), glycopeptides, and glycolipids (e. g., sphingomyelin and the ganglioside GM2).

Another group of suitable analytes includes ions. These ions may be inorganic or organic. Examples include calcium, sodium, chlorine, magnesium, potassium, bicarbonate, phosphate, carbonate, citrate, acetate, choline and combinations thereof. The sensor is also useful for detecting proteins and peptides (the latter being lower molecular weight versions of the former); a number of physiological states are known to alter the level of expression of proteins in blood and other body fluids. Included in this group are enzymes (e. g., enzymes associated with cellular death such as LDH, SGOT, SGTT, and acid and alkaline phosphatases), hormones associated with pregnancy such as human chorionic gonadotropin), lipoproteins (e. g., high density, low density, and very low density lipoprotein), and antibodies (e. g., antibodies to autoimmune diseases such as AIDS, myasthenia gravis, and lupus). Antigens and haptens are also suitable analytes.

Additionally, the sensor can detect analytes such as steroids (e. g., cholesterol, estrogen, and derivatives thereof). The sensor is also useful for detecting and monitoring substances such as theophylline and creatinine.

The sensor may also be used to detect and monitor pesticides and drugs. As used herein, “drug” refers to a material that, when ingested, inhaled, absorbed or otherwise incorporated into the body produces a physiological response. Included in this group are alcohol, therapeutic drugs (e. g., chemotherapeutic agents such as cyclophosphamide, doxorubicin, vincristine, etoposide, cisplatin, and carboplatin), narcotics (e. g., cocaine and heroin) and psychoactive drugs (e. g., LSD).

The sensor may also be used to detect and monitor polynucleotides (e. g., DNA and RNA). The sensor can be used, e.g., to assay overall DNA levels as a measure of cell lysis. Alternatively, the sensor can be used to assay for expression of specific sequences (e. g., HIV RNA).

The sensor can be used in vivo or in situ. For in vivo applications, the sensor can be placed in, on or under the skin, in an organ or a vessel (e.g., a vein or artery).

The analyte can be detected by exciting the sensor (e.g., directly or transdermally exciting an implanted sensor), and detecting the fluorescence signal emitted by the sensor (e.g., directly or transdermally detecting fluorescence emitted by an implanted sensor).

The invention will now be described by way of the following examples.

### EXAMPLES

Test Procedures

Test procedures used in the examples include the following.

Fluorescence Leakage Measurement Method

Sensors are prepared and the amount of fluorescence reagent present in each sensor is calculated. The sensors are placed in excess pH 7.4 10 mM HEPES/0.15 M saline and incubated overnight at 37° C. to remove residue on the surface of the sensors. The supernatant is removed from the sensors and the fluorescence emission spectrum of the supernatant is measured using a Model QM-1 PTI Quantum Master Spectrofluorimeter (PTI Quantum Master, South Brunswick, N.J.). The emission spectrum is measured by exciting the supernatant near the excitation maxima of a fluorophore of the reagent and measuring the emission over a wavelength range that encompasses the emission maxima of the fluorophore. When multiple different fluorophores are present in the fluorescence reagent, the previous step is repeated for each of the different fluorophores. The sensors are then placed in an additional excess volume of fresh HEPES/saline and the sensors are incubated overnight at 37° C., after which the HEPES/saline solution is removed.

A sufficient number (N) of sensors are placed in a test tube along with a sufficient volume of HEPES/saline such that if 100% leakage of the fluorescent dye occurred, the resulting concentration in the supernatant would be 10⁻¹⁰ moles of fluorophores/mL of supernatant. A number of similar test tubes are prepared to provide a sufficient number of samples for the study. The measurements are made in triplicate, i.e., an aliquot is taken from three different test tubes for each time point.

A sample aliquot 100 uL sample of the HEPES/saline solution is removed from three of the test tubes and a fluorescence measurement is obtained for each of the three samples. These samples define time 0. The remaining samples are then incubated at 37° C. for the desired time period. At each time point a sample aliquot is removed from three of the test tubes and a fluorescence measurement is taken on each of the aliquots as described above. If fluorescence is detected, then the sample is filtered using a filter capable of filtering out the free fluorescence dye and retaining the fluorescence reagent (10 kDa MW cutoff Centricon filter (Amicon, a division of W R Grace)) and the fluorescence of the eluant is measured to determine the amount of free dye.

The percent leakage of labeled protein is determined by calculating
(fluorescence intensity of supernatant−fluorescence intensity of eluant)/(fluorescence intensity of solution dye mixture equivalent to Number of sensors (N) per volume of HEPES/saline mL).
Preparation of Microsphere Beads Including Fluorescence Reagent

A volume of a solution of Cy3.5 HSA (human serum albumin, molecular weight 66,430 g/mol) and Cy5.5-ConA (concanavalin A, molecular weight 104,000 g/mol) in pH 7.4 10 mM HEPES/0.15 M saline is added to an equal volume of a sterile 3% alginate in HEPES/saline solution. The solution is mixed on a rocker for five minutes. The mixture is then centrifuged and drawn into a syringe with a 14 gauge catheter. Air bubbles are removed from the sample. The 14 gauge catheter is removed and replaced with a 24 gauge catheter. The plunger of the syringe is then slowly pressed to allow alginate drops to fall into a test tube containing 25 ml of the HEPES/saline solution and 1.5% (w/v) anhydrous calcium chloride. The beads are soaked for 20 minutes.

The beads are then rinsed four times with a HEPES/saline solution and 2 mM calcium chloride and then stored in the HEPES/saline solution.

### Comparative Example 1

A 0.2% monodisperse polylysine (Boehringer Mannheim) coating solution (in HEPES/saline solution) is prepared from a 1% monodisperse polylysine having 33 peptide residues in HEPES/saline buffer stock solution that has been then heated to 37° C. The volume of the first coating solution is fifteen times the volume of the microsphere beads being coated. The volume of the second coating solution is ten times the volume microsphere beads being coated. Both solutions are sterile filtered and kept at 37° C.

Microsphere sensor beads including a first fluorescent reagent components, Cy3.5 HSA (human serum albumin, molecular weight 66,430 g/mol) and a second fluorescent component Cy5.5-ConA (concanavalin A, molecular weight 104,000 g/mol), are coated with a volume of the polylysine coating solution that is fifteen times the volume of the microsphere beads on a rocker for five minutes at 37° C. The beads are removed and rinsed three times with HEPES/saline solution. The beads are then incubated for 60 minutes at room temperature in the HEPES/saline solution while being protected from light. After 60 minutes the HEPES/saline solution is removed from the beads. A second volume of the polylysine coating solution is added to the microsphere beads. The second volume of polylysine coating solution is ten times the volume of the microsphere beads and the beads are incubated in the polylysine coating solution on a rocker for five minutes at 37° C. The beads are then removed and rinsed three times with HEPES/saline solution.

### Comparative Example 2

Polylysine coated microsphere beads are prepared as described in Comparative Example 1 with the exception that the polylysine of Comparative Example 2 had 47 peptide residues.

### Comparative Example 3

Polylysine coated microsphere beads are prepared as described in Comparative Example 1 with the exception that the polylysine of Comparative Example 2 had 60 peptide residues.

### Example 1

A 0.2% polydisperse polylysine (Sigma Chemical Company) coating solution (in HEPES/saline solution) is prepared from a 1% polydisperse polylysine in HEPES/saline solution stock solution having a pH of 7.4 and 2 mM calcium chloride. The 0.2% polydisperse polylysine composition is heated to 37° C. The polydisperse polylysine had a weight average molecular weight of 11,200 Da, a number average molecular weight of 9800 Da and a polydispersity index of 1.14.

Alginate microsphere beads including Cy3.5 HSA (human serum albumin, molecular weight 66,430 g/mol) and Cy5.5 ConA (concanavalin A, molecular weight 104,000 g/mol) is placed in a volume of the polylysine coating solution that is fifteen times greater than the volume of the beads and the beads are incubated in the polylysine coating solution on a rocker for fifteen minutes at 37° C. The beads are then removed from the polylysine solution and rinsed three times with the HEPES/saline solution and 2 mM calcium chloride.

The beads are then incubated in the HEPES/saline solution for 60 minutes at room temperature, while being protected from light. After 60 minutes the HEPES/saline solution is removed from the beads and a second volume of the polylysine coating solution, which is ten times the volume of the beads, is added to the beads, and the beads are incubated in the polylysine solution on a rocker for fifteen minutes at 37° C.

The coated beads are then removed and rinsed three times with the HEPES/saline solution.

The coated beads are then stored overnight at 4° C. in the HEPES/saline solution in a sterile test tube.

The coated beads are then further coated with a 1.5% UP alginate solution and then placed in a solution of HEPES pH 7.2 and 1.5% calcium chloride for ten minutes.

A percent leakage assay is performed on each set of polylysine coated beads of Example 1 and the Comparative Examples. The beads are stored at 37° C. for three days and rinsed with HEPES/saline solution daily. Leakage of the fluorescent components, Cy5.5 and Cy3.5, of the beads is measured periodically over a period of 50 days after a three day rinsing period according to the Fluorescence Leakage Measurement Method set forth above. In particular, the amount of fluorescence reagent present in the beads of Example 1 and the Comparative Examples was calculated. A number (180) of the beads are placed in 30 mL HEPES/saline solution and incubated overnight at 37° C. to remove residue on the surface of the beads. The supernatant is removed from the beads and the fluorescence emission of the supernatant was measured. The beads are then placed in 20 mL of fresh HEPES/saline solution and incubated overnight at 37 ° C., after which the HEPES/saline solution is removed.

The emission spectrum is obtained by exciting the supernatant at 570 nm and measuring the emission over the range from 575 nm to 625 nm. A second spectrum is obtained by exciting the supernatant at 660 nm and measuring the emission over the range from 670 nm to 725 nm.

Ten beads are then placed in each of 18 test tubes with 2 mL HEPES/saline solution. A 100 uL sample aliquot of the HEPES/saline solution is removed from three of the test tubes and a fluorescence measurement is obtained for each of the three samples. These samples define time 0. The remaining samples continued to be incubated at 37 ° C. At the desired time point, a sample aliquot is removed from three of the test tubes and a fluorescence measurement is taken. If fluorescence is detected, then the sample is filtered using a 10 kDa MW cutoff Centricon filter (Amicon, a division of W. R. Grace), which is capable of filtering out the free fluorescence dye and retaining the fluorescent reagents. The fluorescence of the eluant is measured to determine the amount of free dye.

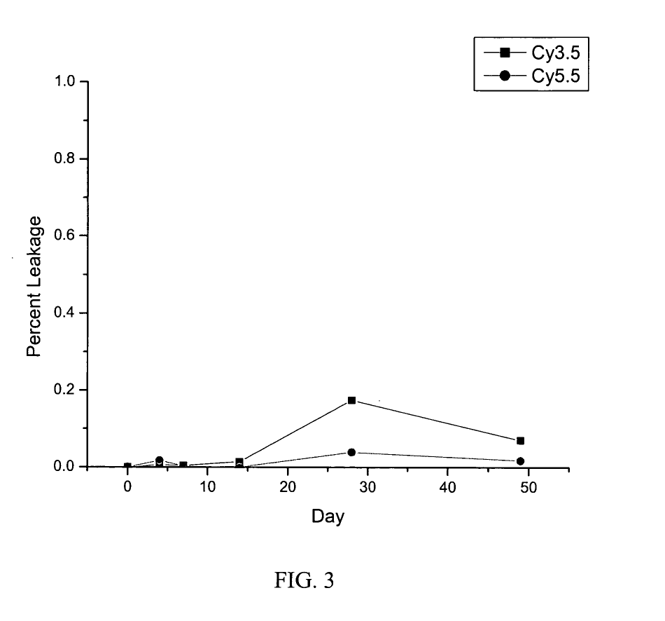

The results are plotted in FIG. 3, wherein the squares represent the percent leakage of Cy3.5 and the circles represent the percent leakage of Cy5.5.

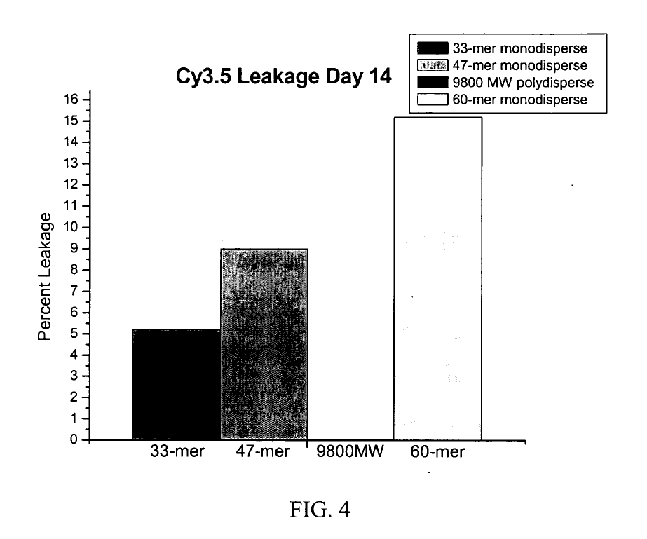

The amount of Cy3.5 leakage at day 14 for the beads prepared according to Comparative Examples 1-3 and Example 1 is illustrated by a bar graph in FIG. 4.

Other embodiments are within the claims.

1. A sensor for detecting an analyte, said sensor comprising:
a core comprising hydrogel;
fluorescence reagent disposed in the core;
a semipermeable coating surrounding the core, the semipermeable coating comprising a polydisperse polymer having a molecular weight from about 4 kDa to about 18 kDa and a polydispersity index greater than 1; and
a biocompatible coating surrounding the semipermeable coating.

2. The sensor of claim 1, wherein the polydisperse polymer has a molecular weight from about 8 kDa to about 12 kDa.

3. The sensor of claim 1, wherein the polydisperse polymer has a molecular weight from from about 9 kDa to about 10 kDa.

4. The sensor of claim 1, wherein the fluorescence reagent is mobile in the core.

5. The sensor of claim 1, wherein the polydisperse polymer has a polydispersity index from greater than 1 to about 1.5.

6. The sensor of claim 1, wherein the polydisperse polymer comprises polylysine.

7. The sensor of claim 1, having a diameter greater than 1 mm.

8. The sensor of claim 1, having a diameter of at least 1.25 mm.

9. The sensor of claim 1, having a diameter of at least 1.5 mm.

10. The sensor of claim 1, having a diameter no greater than 3 mm.

11. The sensor of claim 1, having a diameter no greater than 2.5 mm.

12. The sensor of claim 1, wherein the analyte comprises glucose.

13. The sensor of claim 1, wherein said sensor is capable of detecting the analyte based on nonradiative fluorescence resonance energy transfer.

14. The sensor of claim 1, wherein the fluorescence reagent comprises an energy acceptor and an energy donor.

15. The sensor of claim 1, wherein the fluorescence reagent is selected from the group consisting of carbocyanine dyes, sulfonated aminocourmarin dyes, sulfonated rhodamine dyes, and combinations thereof.

16. The sensor of claim 1, wherein the fluorescence reagent comprises glucose binding protein and a glycosylated substrate.

17. The sensor of claim 16, wherein the glucose binding protein comprises concanavalin A and the substrate comprises human serum albumin.

18. The sensor of claim 1, wherein the fluorescence reagent comprises a first carbocyanine dye having an excitation maximum at 581 nm and an emission maximum at 596 nm, concanavalin A, a second carbocyanine dye having an excitation maxima at 675 nm and an emission maxima at 694 nm, and human serum albumin.

19. The sensor of claim 18, wherein said concanavalin A comprises recombinant concanavalin A.

20. The sensor of claim 18, wherein the molar ratio of the first carbocyanine dye to concanavalin A is from about 0.1 to about 0.4.

21. The sensor of claim 18, wherein the molar ratio of the first carbocyanine dye to concanavalin A is 0.2.

22. The sensor of claim 18, wherein the molar ratio of the second carbocyanine dye to human serum albumin is from about 0.5 to about 0.9.

23. The sensor of claim 14, wherein the human serum albumin is glycoslyated and the molar ratio of glucose to human serum albumin is from about 7 to about 12.

24. The sensor of claim 1, wherein the fluorescence reagent comprises a first dye having an excitation maxima at about 578 nm and an emission maxima at about 603 nm, concanavalin A, a second dye having an excitation maxima at about 650 nm and an emission maxima at about 665 nm, and human serum albumin.

25. A method of making a sensor comprising contacting droplets of a first aqueous alginate composition with an ionic solution comprising at least 100 mM Group II cations to form a core comprising crosslinked gel, said first aqueous alginate composition comprising a 1:1 dilution of a stock composition comprising at least 1% weight/volume alginate and having a viscosity of at least 1700 centipoises at about 25° C.

26. The method of claim 25, wherein said ions comprise barium ions, calcium ions or a combination thereof.

27. The method of claim 25, wherein said first aqueous alginate composition comprises from about 1% weight/volume to about 10% weight/volume alginate.

28. The method of claim 25, wherein said alginate composition comprises from about 1% weight/volume to about 3% weight/volume alginate.

29. The method of claim 25, wherein said stock composition has a viscosity from about 1700 cps to about 2000 cps at about 25° C.

30. The method of claim 25, wherein said ionic solution comprises from about 100 mM cations to about 300 mM cations.

31. The method of claim 25, further comprising coating said core with a composition comprising polydisperse polymer having a polydispersity index greater than 1.

32. The method of claim 25, further comprising coating said core with a composition comprising polydisperse polymer having a polydispersity index from greater than 1 to about 1.5.

33. The method of claim 31, further comprising coating said polydisperse polymer coating with a biocompatible composition.

34. The method of claim 23, further comprising contacting said core with a composition comprising a fluorescence reagent.

35. The method of claim 25, wherein said aqueous alginate composition comprises a fluorescence reagent.

36. The method of claim 35, wherein the fluorescence reagent comprises an energy donor and an energy acceptor.

37. The method of claim 35, wherein the fluorescence reagent comprises glucose binding protein and a glycosylated substrate.

38. The method of claim 37, wherein the glucose binding protein comprises concanavalin A and the glycosylated substrate comprises human serum albumin.

39. The method of claim 35, wherein the fluorescence reagent is selected from the group consisting of carbocyanine dyes, sulfonated aminocourmarin dyes, sulfonated rhodamine dyes, and combinations thereof.

40. The method of claim 35, wherein the fluorescence reagent comprises a first carbocyanine dye having an excitation maximum at 581 nm and an emission maximum at 596 nm, concanavalin A, a second carbocyanine dye having an excitation maxima at 675 nm and an emission maxima at 694 nm, and human serum albumin.

41. The method of claim 40, wherein the molar ratio of the first carbocyanine dye to concanavalin A is from about 0.1 to about 0.4.

42. The method of claim 40, wherein the molar ratio of the first carbocyanine dye to concanavalin A is 0.2.

43. The method of claim 40, wherein the molar ratio of the second carbocyanine dye to human serum albumin is from about 0.5 to about 0.9.

44. The method of claim 37, wherein the glucose binding protein comprises concanavalin A and the glycosylated substrate comprises human serum albumin.

45. The method of claim 37, wherein the human serum albumin is glycoslyated and the molar ratio of glucose to human serum albumin is from about 7 to about 12.

47. The method of claim 35, wherein the fluorescence reagent comprises a first dye having an excitation maxima at about 578 nm and an emission maxima at about 603 nm, concanavalin A, a second dye having an excitation maxima at about 650 nm and an emission maxima at about 665 nm, and human serum albumin.

48. The sensor of claim 1, wherein the sensor exhibits less 1 mole % leakage of its fluorescence reagent when stored for two weeks at 37° C. in pH 7.4 10 mM HEPES/0.15 M saline solution.

49. A sensor for detecting an analyte, said sensor comprising:
a core comprising a polymer matrix;
fluorescence reagent disposed in the core;
a semipermeable coating surrounding the core, the semipermeable coating comprising a polydisperse polymer; and
a biocompatible coating surrounding the semipermeable coating, the sensor exhibiting less than 1 mole % leakage of the fluorescence reagent when stored for two weeks at 37° C. in pH 7.4 10 mM HEPES/0.15 M saline solution.
